(19) United States
(12) Patent Application Publication
(10) Pub. No.: US 2013/0142017 A1
(43) Pub. Date: Jun. 6, 2013

(54) Reminding Method and Device for Playing Sound According to Control or According to Spending Amount in Real Time

(71) Applicant: Huawei Technologies Co., Ltd., Shenzhen (CN)

(72) Inventor: Peng Ding, Shenzhen (CN)

(73) Assignee: HUAWEI TECHNOLOGIES CO., LTD., Shenzhen (CN)

(21) Appl. No.: 13/756,738

(22) Filed: Feb. 1, 2013

Related U.S. Application Data
(63) Continuation of application No. PCT/CN2011/083435, filed on Dec. 5, 2011.

(30) Foreign Application Priority Data
Dec. 16, 2010 (CN) 201010592425.8

(51) Int. Cl. G04F 1/00

(52) U.S. Cl. CPC G04F 1/005
USPC 368/109

(57) ABSTRACT

A reminding method and device for playing a tone according to control or according to spending amount in real time. The method comprises: receiving, from a charging system, an interval duration of playing a tone which is related to having spent the fixed amount; setting an interval duration of playing a tone for reminding of the spending of the fixed amount according to the interval duration of playing a tone which is related to having spent the fixed amount; and when a call duration of a user reaches the interval duration of playing a tone for reminding of the spending of the fixed amount, playing the tone which is for reminding of having spent the fixed amount to the user. The present invention solves the problem in the prior art that real-time sound play reminding cannot be performed on the user based on spending amount.

### CROSS-REFERENCE TO RELATED APPLICATIONS

This application is a continuation of International Application No. PCT/CN2011/083435, filed on Dec. 5, 2011, which claims priority to Chinese Patent Application No. 201010592425.8, filed on Dec. 16, 2010, both of which are hereby incorporated by reference in their entireties.

### STATEMENT REGARDING FEDERALLY SPONSORED RESEARCH OR DEVELOPMENT

Not applicable.

### REFERENCE TO A MICROFICHE APPENDIX

Not applicable.

### TECHNICAL FIELD

The present invention generally relates to the field of communication techniques, and more particularly, to a reminding method for playing sound according to spending amount in real time, and a method and device for controlling the playing of a tone according to spending amount in real time.

### BACKGROUND

With development of communication techniques, service requirements for communication users are growing as well. At present, some users for the integration charging system (e.g., an online charging system (OCS)) and intelligent network desire to obtain a prompt once spending a fixed amount during a conversation, in order for controlling their own spending. Especially for countries that have expensive communicating fees, the need of such functionality is highly required. However, for Customized Applications for Mobile Network Enhanced Logic (CAMEL) protocol based Global System of Mobile communication (GSM) network, such as either the traditional intelligent network or the latest integration charging system (e.g., OCS), a normal interaction for origination protocols is always conducted based on the timing diagram for a specified signaling procedure. In order to guarantee the stability of a conversation, after a service control point (SCP) receives an o-answer response message and stabilizes the conversation, the SCP then cannot instruct a service support point (SSP)/universal resource platform (URP) to perform sound play anymore. This is because, in the 3rd Generation Partnership Project (3GPP) specifications, the signaling timing for a management object (MO) flow is explicitly stated, sound play for the European Telecommunications Standard Institute technical report (ETR)/connection to resource (CTR) must occur before receiving the o-answer.

During the study and practice on the prior art, the inventor of the present invention observes that: in the GSM network using CAMEL protocol, based on existing signaling flow, the reestablishing of the link for sound play is unable to be done during a conversation, thus instructing a mobile service switching center (MSC)/URP to play sound. In doing this, the functionality of performing real-time sound play reminding on a user according to spending amount cannot be realized during a conversation for the user.

### SUMMARY

The present invention provides a reminding method for playing a tone according to spending amount in real time, and a method and device thereof for controlling the playing of a tone according to spending amount in real time, in order to address the problem of being unable to perform real-time sound play reminding on a user in the prior art.

For addressing the technical problem described above, an embodiment of the present invention provides a reminding method for playing a tone according to spent amount in real time, the method comprising: receiving an interval duration of playing a tone from a charging system, wherein the tone relates to having spent a fixed amount; according to the received interval duration of playing a tone which is related to having spent the fixed amount, setting an interval duration of playing a tone, wherein the tone is for reminding of having spent the fixed amount; and when a call duration of a user reaches the interval duration of playing the tone which is for reminding of having spent the fixed amount, playing the tone which is for reminding of having spent the fixed amount to the user.

Accordingly, an embodiment of the present invention further provides a reminding device for playing a tone according to spent amount in real time, the device comprising: a first receiving unit for receiving an interval duration of playing a tone from a charging system, wherein the tone relates to having spent a fixed amount; a first setting unit for setting an interval duration of playing a tone, wherein the tone is for reminding of having spent the fixed amount according to the received interval duration of playing a tone which is related to having spent the fixed amount; and a first reminding unit for playing the tone which is for reminding of having spent the fixed amount to the user when a call duration of a user reaches the interval duration of playing the tone which is for reminding of having spent the fixed amount.

Accordingly, an embodiment of the present invention further provides a reminding device for controlling of playing a tone according to spent amount in real time, the device comprising: a first receiving unit for receiving, transmitted by the charging system, the interval duration of playing a tone which is related to having spent the fixed amount; and a first transmitting unit for transmitting the interval duration of playing a tone which is related to having spent the fixed amount to a mobile service switching center, so that the mobile service switching centre plays a reminding tone to the user according to the interval duration of playing a tone which is related to having spent the fixed amount.

As known from the above described technical solutions, the MSC, after receiving a charging request carrying an interval duration of playing the tone corresponding to spending the fixed amount, sets an interval duration of playing a tone for reminding of having spent the fixed amount according to the received interval duration of playing a tone which is related to having spent the fixed amount, and when a call duration of a user reaches the interval duration of playing the tone which is for reminding of having spent the fixed amount, plays a reminding tone to the user. That is, when meeting conditions for playing a tone, a reminding tone is played to the user. The present embodiment addresses the problem of performing real-time sound play reminding on a user according to the user's spending of fixed amount, improving the user experience.

### BRIEF DESCRIPTION OF THE DRAWINGS

To more clearly illustrate the technical solutions in embodiments of the present invention or in the prior art, the drawings which are used to illustrate the embodiments or the prior art will be simply introduced. Obviously, the drawings in the following description are only some embodiments of the present invention. Persons skilled in the art can obtain other drawings based on these drawings without inventive work.

FIG. 1 is a flow diagram illustrating a reminding method for playing a tone according to spending amount in real time, which is provided by an embodiment of the present invention;

FIG. 2 is a flow diagram illustrating a further method for controlling playing a tone according to spending amount in real time, which is also provided by an embodiment of the present invention;

FIG. 3 is a flow diagram illustrating an application instance, which is provided by an embodiment of the present invention;

FIG. 4 is a schematic diagram of the structure illustrating a reminding apparatus for playing a tone according to spending amount in real time, which is provided by an embodiment of the present invention; and

FIG. 5 is a reminding apparatus for controlling of playing a tone according to spending amount in real time, which is provided by an embodiment of the present invention.

### DETAILED DESCRIPTION

Embodiments of the present invention are further detailed in connection with accompanying drawings and implements, in order to enable those skilled in the art to better understand solutions of the embodiments of the present invention.

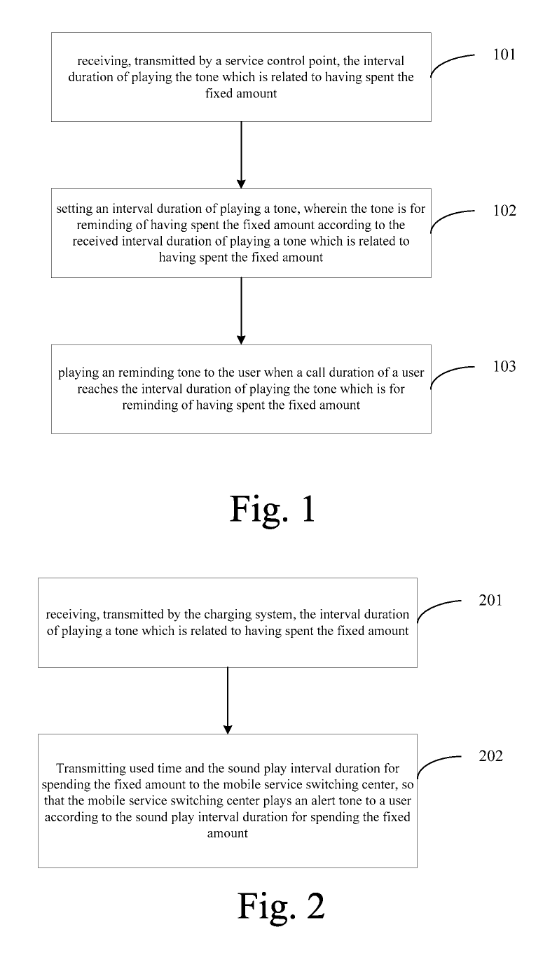

Referring to FIG. 1, a flow diagram illustrating a reminding method for playing a tone according to spending amount in real time, which is provided by the present invention, is presented, the method comprises:

Step 101: receiving, transmitted by a service control point, the interval duration of playing the tone which is related to having spent the fixed amount.

In this embodiment, the interval duration of playing a tone which is related to having spent the fixed amount is an interval duration between two times when a reminding tone is played to the user due to spending of the fixed amount. For example, the system plays a tone to the user according to this interval duration of playing the tone, so as to remind the user of having spent the fixed amount. For example, the interval duration of playing a tone is equal to a fixed amount divided by a calling fee-rate (e.g., interval duration=X amount/calling fee-rate, wherein X amount is the fixed amount).

Specifically, a charging request message can be used, wherein the charging request message comprises: the interval duration of playing a tone which is related to having spent the fixed amount (wherein, the interval duration of playing a tone is VoiceTimeStep); or a duration after which a fee-rate will be switched, i.e., RateChangeTime. Alternatively, the charging request message also comprises other parameters, such as usable time for spending the fixed amount, and the usable time is larger than or equal to the interval duration of playing a tone. The usable time is the time during which service can be used through spending the fixed amount, for example, money of the fixed amount determines how long a conversation lasts, etc.

Step 102: setting an interval duration of playing a tone, wherein the tone is for reminding of having spent the fixed amount according to the received interval duration of playing a tone which is related to having spent the fixed amount.

Step 103: playing the tone which is for reminding of having spent the fixed amount to the user when a call duration of a user reaches the interval duration of playing the tone which is for reminding of having spent the fixed amount.

In this embodiment, the spending of the fixed amount relates to account amount that the user spends during a conversation, the value of which is relatively specific. As an example, if the spending of the fixed amount is set to be $5, a reminding tone is then played to the user whenever the user spends $5 during a single conversation.

As another example, if the spending is recorded always per $5, $10, $20, or other amount during a conversation, there is also a case that the first spending is $a during the previous period of the conversation, and the second spending is $b during the latter period of the conversation. As a specific example, for a conversation of a user, the reminding of the spending of $10 is received by the user whenever $10 is spent during the previous period of the conversation; and after five times of the reminding of the spending of $10 have occurred, the reminding of the spending of $5 is received by the user whenever $5 is spent during the latter period of the conversation. The fixed amount is not limited by the balance of the user, and the system can also perform voice reminding when the balance is insufficient, which is not limited to the present implement.

In this embodiment, after receiving the charging request carrying the interval duration of playing a tone which is related to having spent the fixed amount transmitted from the service control point (SCP), the MSC sets the interval duration of playing a tone for reminding of the spending of the fixed amount according to the received interval duration of playing a tone, and plays a reminding tone to the user when the interval duration of playing a tone for the reminding of the spending of the fixed amount is reached (that is, plays a reminding tone to the user when the condition for playing a tone is met). This embodiment implements that the mobile switching center can perform real-time sound play reminding on a user according to the user's spending of the fixed amount.

Preferably, the mobile switching center receives a duration after which a fee-rate will be switched, in addition to receiving the interval duration of playing a tone which is related to having spent the fixed amount transmitted from a service control point (SCP), wherein, the duration after which a fee-rate will be switched is the duration between the time point when the fee-rate is switched and the beginning of a conversation. The SCP can transmit the duration after which a fee-rate will be switched according to the charging request message.

In the present embodiment, when the fee-rate changes, the charging system needs to compute the duration after which a fee-rate will be switched and transmit the duration after which a fee-rate will be switched to the SCP through the credit control answer (CCA), wherein the duration after which a fee-rate will be switched is the result of subtracting the present time from the time point when the fee-rate is switched, and the time point when the fee-rate is switched depends on specific charges configured by the user.

Preferably, when the duration after which a fee-rate will be switched changes, the method further comprises: the MSC transmits a charging request report to the service control point according to the duration after which a fee-rate will be switched, so that the service control point obtains a re-precomputed interval duration of playing a tone corresponding to spending the fixed amount from the charging system; the MSC receives, transmitted from the service control point, the duration after which a fee-rate will be switched and the interval duration of playing a tone corresponding to spending the fixed amount re-precomputed by the charging system; the MSC sets the interval duration of playing a tone for the reminding of the spending of the fixed amount according to the duration after which a fee-rate will be switched and the re-precomputed interval duration of playing a tone corresponding to spending the fixed amount; and the MSC plays a reminding tone to the user when the re-precomputed interval duration of playing a tone which is related to having spent the fixed amount is reached.

That is, when the duration after which a fee-rate will be switched changes, the MSC transmits the charging request report to the SCP according to the duration after which a fee-rate will be switched; the SCP transmits a credit control request to the charging system; after receiving the credit control request, the charging system re-precomputes the interval duration of playing a tone corresponding to spending the fixed amount, the formula for computing which is the spent fixed amount divided by the calling fee-rate (e.g., interval duration=spent fixed amount/the calling fee-rate); thereafter, the charging system transmits the re-precomputed interval duration of playing a tone corresponding to spending the fixed amount and the duration after which a fee-rate will be switched as well as available time to the SCP; the SCP then transmits the re-precomputed interval duration of playing a tone corresponding to spending the fixed amount and the duration after which a fee-rate will be switched to the MSC, the MSC resets the interval duration of playing a tone for the reminding of the spending of the fixed amount according to the received re-precomputed interval duration of playing a tone corresponding to spending the fixed amount and the duration after which a fee-rate will be switched, and playing the tone which is for reminding of having spent the fixed amount to the user when the re-precomputed interval duration of playing a tone which is related to having spent the fixed amount is reached, wherein the playing the reminding tone to the user can be conducted through setting a timer for playing a tone.

Preferably, the method can further comprise: after communication of the user terminates, the MSC transmits a charging request report of the time having been used by the user to the service control point; and when receiving, transmitted by the service control point, a communication-terminating message after finishing fee-deduction, the communication is switched off.

The method can further comprise:

The service control point receives the interval duration of playing a tone which is related to having spent the fixed amount transmitted from the charging system, and the service control point transmits used time and the interval duration of playing a tone which is related to having spent the fixed amount to the mobile service switching center.

Preferably, when the duration after which a fee-rate will be switched changes, the method can further comprise:

The service control point receives the charging request report transmitted by the mobile service switching center according to the duration after which a fee-rate will be switched, and the service control point obtains the duration after which a fee-rate will be switched and the re-precomputed interval duration of playing a tone corresponding to spending the fixed amount from the charging system according to the charging request report.

The re-precomputed interval duration of playing a tone corresponding to spending the fixed amount and the duration after which a fee-rate will be switched are transmitted to the mobile service switching center, so that the mobile service switching center resets a re-precomputed interval duration of playing a tone which is related to having spent the fixed amount according to the received re-precomputed interval duration of playing a tone corresponding to spending the fixed amount and the duration after which a fee-rate will be switched, and plays a reminding tone to the user when the re-precomputed interval duration of playing a tone which is related to having spent the fixed amount is reached.

Preferably, the service control point obtaining the re-precomputed interval duration of playing a tone corresponding to spending the fixed amount and the duration after which a fee-rate will be switched from the charging system specifically comprises:

Transmitting a credit control request to the charging system according to the content of the charging request report, and receiving a credit control response transmitted by the charging system, wherein the credit control response comprises the re-precomputed interval duration of playing a tone corresponding to spending the fixed amount and the duration after which a fee-rate will be switched.

In the embodiments of the present invention, through an extension of the charging request applying charge (AC) message in the CAMEL protocol, the charging request AC message can carry parameters for the interval duration of playing a tone which is related to having spent the fixed amount, and meanwhile, if the fee-rate changes, can also carry parameters for the duration after which a fee-rate will be switched computed by the charging system. The MSC can set sound play content and interval duration of playing a tone according to the sound play parameters in the AC, and can also dynamically adjust interval duration of playing a tone in real-time. In doing so, the real-time sound play reminding can be performed for the user's spending of the fixed amount in the GSM network.

By further referring to FIG. 2, a flow diagram illustrating a further method for controlling of playing a tone according to spending amount in real time, which is also provided by an embodiment of the present invention is disclosed, the method comprises:

Step 201: receiving, transmitted by the charging system, the interval duration of playing a tone which is related to having spent the fixed amount.

Step 202: transmitting the used time and the interval duration of playing a tone which is related to having spent the fixed amount to a mobile service switching center, so that the mobile service switching centre plays a reminding tone to the user according to the interval duration of playing a tone which is related to having spent the fixed amount.

Specifically, the used time and the interval duration of playing a tone which is related to having spent the fixed amount can be transmitted to the mobile service switching center through a charging request.

In the present embodiment, the SCP receives a control acknowledge (e.g., a credit control acknowledge) transmitted by the charging system after transmitting a control request (e.g., the credit control request) to the charging system, the control acknowledge comprises an interval duration of playing a tone which is related to having spent the fixed amount; the SCP transmits a charging request (e.g., an AC) message to the MSC and populates extended parameters in the AC message with the interval duration of playing a tone which is related to having spent the fixed amount, the MSC setting an interval duration of playing a tone for reminding of the spending of the fixed amount according to the received interval duration of playing a tone; and a reminding tone is played to a user when a call duration of the user reaches the interval duration of playing a tone for the reminding of the spending of the fixed amount.

In the present embodiment, extension to the AC message in the CAMEL protocol is mainly directed, i.e., in extended fields of the AC message, parameters for carrying the interval duration of playing a tone and the duration after which a fee-rate will be switched can be added. Further, parameters for the duration after which a fee-rate will be switched can be added. That is to say, the SCP can obtain the interval duration of playing a tone which is related to having spent the fixed amount from the charging system, and transmit the interval duration of playing a tone which is related to having spent the fixed amount to the MSC through an extended AC message, so that controlling the MSC to play a reminding tone to a user according to the interval duration of playing a tone which is related to having spent the fixed amount.

Preferably, the duration after which a fee-rate will be switched is also received from the charging system, and the duration after which a fee-rate will be switched is transmitted to the mobile service switching center through the charging request.

When the duration after which a fee-rate will be switched changes, the method further comprises: the SCP receives the charging request report transmitted by the mobile service switching center according to the duration after which a fee-rate will be switched; obtains a re-precomputed interval duration of playing a tone corresponding to spending the fixed amount and the duration after which a fee-rate will be switched from the charging system; and transmits the re-precomputed interval duration of playing a tone corresponding to spending the fixed amount and the duration after which a fee-rate will be switched to the mobile service switching center, so that controlling the mobile service switching center to reset a re-precomputed interval duration of playing a tone which is related to having spent the fixed amount according to the re-precomputed interval duration of playing a tone corresponding to spending the fixed amount and the duration after which a fee-rate will be switched, and to play a reminding tone to the user when the re-precomputed interval duration of playing a tone which is related to having spent the fixed amount is reached.

The obtaining of the re-precomputed interval duration of playing a tone corresponding to spending the fixed amount and the duration after which a fee-rate will be switched from the charging system specifically comprises: transmitting the credit control request to the charging system according to the content of the charging request report; receiving the credit control response transmitted by the charging system, wherein the credit control response comprises the re-precomputed interval duration of playing a tone corresponding to spending the fixed amount and the duration after which a fee-rate will be switched.

In the present embodiment, because the computing system supports combining the fixed amount with the present personal charge, it can inversely-compute the conversation duration corresponding to the fixed amount; further dynamically inversely-compute new conversation duration and duration after which a fee-rate will be switched in real time when the fee-rate changes; and transmits them to the MSC through SCP, so that controlling the MSC to reset a re-precomputed interval duration of playing a tone which is related to having spent the fixed amount according to the re-precomputed interval duration of playing a tone corresponding to spending the fixed amount and the duration after which a fee-rate will be switched, and to play a reminding tone to the user when the re-precomputed interval duration of playing a tone which is related to having spent the fixed amount is reached.

Preferably, the charging system in the present embodiment can be the integration charging system, and can also be other charging systems, which is not limited by the present embodiment. Please be advised that, the charging system (e.g., the OCS system) in the present embodiment requires the support of system-level and user-level configured fixed amount (represented by X amount) for the reminding, and can dynamically inversely-compute specific interval duration of playing a tone according to X amount, the formula for computing which is the spent fixed amount divided by the calling fee-rate (e.g., interval duration =the spent fixed amount/the calling fee-rate); the OCS system further requires the support of a system-level flag to control whether the OCS system performs the reminding of X amount according to the system-level flag. The OCS supports a user-level flag to control whether the user starts the functionality of reminding such amount. The priority of the system-level flag is higher than that of the user-level flag, wherein the user-level flag is available only when the system-level flag triggers the functionality of the reminding. The OCS further requires the support of dynamically adjusting the interval duration of playing a tone for the reminding of X amount according to the change of the fee-rate, wherein the interval duration of playing a tone for the reminding of X amount is also dynamically adjusted when the fee-rate switches; for instance, it would take 60 seconds to consume $1 before the change of the fee-rate, thus playing a tone needs to be conducted to the user, however, if it take would 30 seconds to consume $1 after the change of the fee-rate, then the interval duration of playing a tone needs to be adjusted. The OCS supports the system-level flag to control whether to perform the reminding of X amount when roaming occurs, conversation-path-transferring having to be conducted at the switching side to transfer to the MSC of the home network for playing a tone, if performing the reminding of X amount when roaming occurs. The OCS supports to control whether to distribute the extended AC message according to the type of the MSC, so as to allow no exception for interfacing with a third-part MSC due to the extended AC message.

In the present embodiment, the extension to parameters in the AC message is only directed to the extension to the Play Tone parameter in the original AC message, since the Play Tone parameter is mainly used for performing reminding for a real-time conversation when the maximum call duration or the last minute is reached, and thus is not adapted to the reminding of real-time spending of fixed amount. In this regard, in the embodiments of the present invention, new parameters are added into the AC message, including: the interval duration of playing a tone (VoiceTimeStep) and the duration after which a fee-rate will be switched (RateChangeTime).

For better understanding of persons in the art, specific application instances are illustrated as follows.

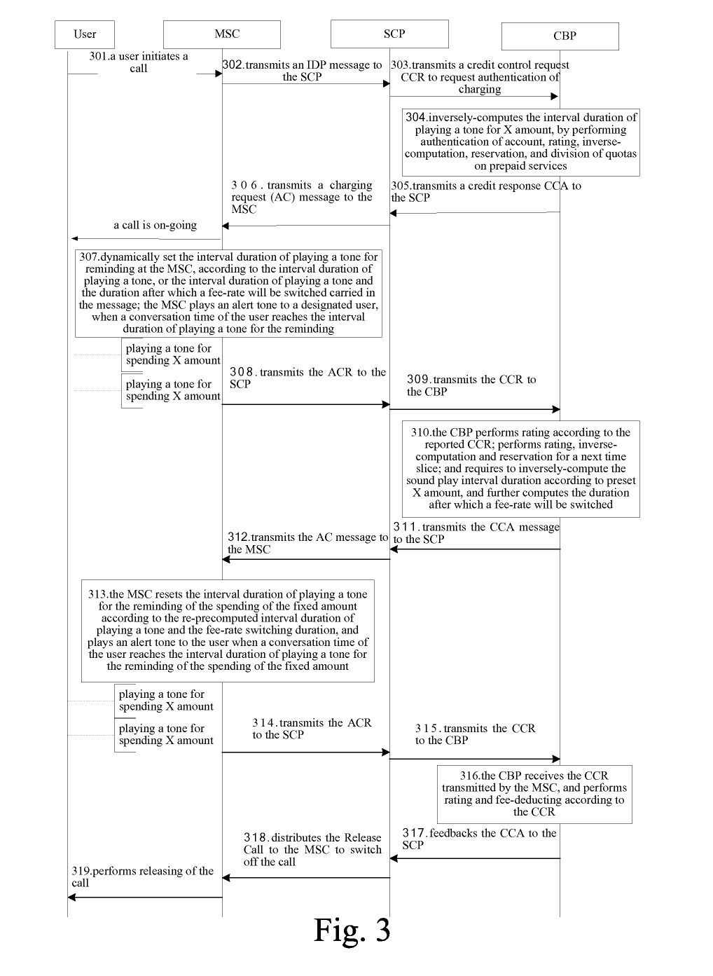

By further referring to FIG. 3, a flow chart of an application instance provided by an embodiment of the present invention is disclosed. In this embodiment, after a call is on-going, a user can hear sound play reminding whenever spending fixed X amount, until the call is released, wherein specific processes at a switching side and charging side are detailed in FIG. 3, in which a charging system is an integration charging system for exemplary purpose, specifically comprising:

Step 301: a user initiates a call, i.e., the user initiates the call to the MSC.

Step 302: the MSC (or the SSP; the present embodiment uses, but being not limited to, the MSC for exemplary purpose) transmits an initial detection point (IDP) message to the SCP.

Step 303: after receiving the IDP message, the SCP transmits a credit control request (CCR) (e.g., an Initial CCR) to the integration charging control point (e.g., a convergent billing platform (CBP)) in the OCS, to request authentication of charging.

After receiving the IDP message, the SCP determines whether to transmit an anytime interrogation (ATI) message to the home location register (HLR) to acquire called location information; meanwhile, the SCP performs the translation of virtual private network (VPN) reduced number, and the determination of whether the calling originates within or from outside of a group net; the SCP transmits related information and results to the integration charging control point (e.g., CBP) in the OCS, to request the authentication of charging.

Step 304: the CBP in the OCS inversely-computes the interval duration of playing a tone for X amount, by performing authentication of account, rating, inverse-computation, reservation, and division of quotas on prepaid services.

That is to say, the CBP in the OCS performs determination on the related information; performs authentication of account, rating, inverse-computation, and reservation on prepaid services; and requires to, according to a predefined configurable parameter of fixed amount (represented by X amount), inversely-compute the interval duration of playing a tone for X amount, the formula for which is the interval duration of playing a tone is equal to the fixed amount divided by the calling fee-rate (e.g., the interval duration of playing a tone=X amount/calling fee-rate).

Further, if the fee-rate is switched, it requires to compute the duration after which a fee-rate will be switched, the formula for which is the duration after which a fee-rate will be switched is equal to the time point when the fee-rate is switched minus the present time (e.g., the duration=the time point when the fee-rate is switched−the present time), wherein the time point when the fee-rate is switched is determined according to specific charge configured by the user.

Step 305: the CBP transmits a credit response (e.g., a CCA) to the SCP, the CCA including usable time, the interval duration of playing a tone, and can further include the duration after which a fee-rate will be switched.

Step 306: the SCP transmits a charging request (e.g., an AC) message to the MSC, the AC message including the interval duration of playing a tone, or the interval duration of playing a tone and the duration after which a fee-rate will be switched.

The SCP populates the interval duration of playing a tone, or the interval duration of playing a tone and the duration after which a fee-rate will be switched received from the CBP into extended parameters in the AC message; and the monitoring of a call is performed at the MSC.

Step 307: the MSC dynamically sets the interval duration of playing a tone for reminding at the MSC, according to the interval duration of playing a tone, or the interval duration of playing a tone and the duration after which a fee-rate will be switched carried in the message; the MSC plays a reminding tone to a designated user, when a call duration of the user reaches the interval duration of playing a tone for the reminding. That is, the reminding tone is played to the designated user when the MSC meets conditions for playing a tone.

This can be implemented through timers set on the MSC; i.e., the original timer is canceled and two new timers are added, one of the two new timers starting to be monitored from the present time with the duration for the monitoring being the duration after which a fee-rate will be switched (this timer is set for only one time), the other one of the two new timers starting to be monitored from the present time with the duration for the monitoring being the interval duration of playing a tone (this timer keeps effective till being reset). For instance, playing a tone will be not conducted, if the interval duration of playing a tone is 0. The fee-rate switching will not occur and the reminding of the playing a tone will be performed according to the interval duration of playing a tone, if the duration after which a fee-rate will be switched is 0. If the duration after which a fee-rate will be switched is not 0, then the MSC reports the applying charging report (ACR) in real time to the SCP according to the duration after which a fee-rate will be switched, and the SCP transmits the CCR to the CBP, so that the CBP re-precomputes the sound play duration corresponding to fixed X amount and delivers it to the MSC through the SCP.

Step 308: the MSC transmits the ACR to the SCP to report the time used by the user.

Step 309: after receiving the ACR, the SCP transmits the CCR (update) to the CBP to report the time used by the user.

Step 310: the CBP performs rating according to the reported CCR; performs rating, inverse-computation and reservation for a next time slice; and requires to inversely-compute the interval duration of playing a tone according to preset X amount, and requires to compute the duration after which a fee-rate will be switched if the fee-rate switching occurs.

Step 311: the CBP transmits the CCA message to the SCP, the CCA message including the re-precomputed interval duration of playing a tone and the duration after which a fee-rate will be switched.

Step 312: the SCP transmits the AC message to the MSC, the AC message including the re-precomputed interval duration of playing a tone and the duration after which a fee-rate will be switched.

Step 313: the MSC resets the interval duration of playing a tone for the reminding of the spending of the fixed amount according to the re-precomputed interval duration of playing a tone and the duration after which a fee-rate will be switched, and plays a reminding tone to the user when a call duration of the user reaches the interval duration of playing a tone for the reminding of the spending of the fixed amount.

When the duration after which a fee-rate will be switched is not 0, the MSC reports the ACR in real time according to the duration after which a fee-rate will be switched, so as to allow the charging system, by the SCP, to re-precompute the interval duration of playing a tone corresponding to the fixed amount and then deliver the interval duration of playing a tone to the MSC through the SCP. A reminding tone is played to a designated user when the MSC meets conditions for playing a tone.

In the aforementioned embodiment, this step will be repeated many times during one conversation, since more than one interaction of transmitting the AC and the ACR can occur in the conversation. The present embodiment illustrates, but is not limited to, two interactions of the AC for exemplary purpose.

Step 314: after the user's conversation terminates, the MSC transmits the ACR to the SCP to advise the termination of the user's conversation.

Step 315: after receiving the ACR, the SCP transmits the CCR (Termination) to the CBP to report the used time.

Step 316: the CBP receives the CCR transmitted by the MSC, and performs rating/fee-deducting according to the CCR.

Step 317: the CBP feeds the CCA to the SCP.

Step 318: the SCP distributes the Release Call to the MSC to switch off the call.

Step 319: the MSC performs releasing of the call.

In the present embodiment, in the case that roaming for the user occurs, if performing of real-time reminding of spending amount is required, then the transferring of routing requires to be conducted at the switching side to finally play sound at the MSC of the home network.

In the present embodiment, through extensions in the AC message of the CAMEL protocol, i.e., through extended new fields in the AC message, the interval duration of playing a tone and duration after which a fee-rate will be switched are separately delivered. In doing so, the MSC sets the content for playing a tone and the interval duration of playing a tone according to the received parameters for playing a tone in the AC, thereby addressing the problem of performing real-time sound play reminding on the user based on spending amount, improving the experience of the user in the GSM network, and attaining the objective of controlling the expenditure for a personal call in real time. In addition, for achieving the functionality of the reminding, the embodiments of the present invention do not need to establish any outbound link for playing a tone, which thus causes less impact on system performance than other schemes with established links for playing a tone. Further, the embodiments of the present invention do not need to frequently distribute the AC according to the duration corresponding to fixed amount, which allows no sharp degradation in the system performance due to frequent interaction of AC/ACR signaling, thus requiring no upgrading of the present network devices and no increase of the operating costs of an operator.

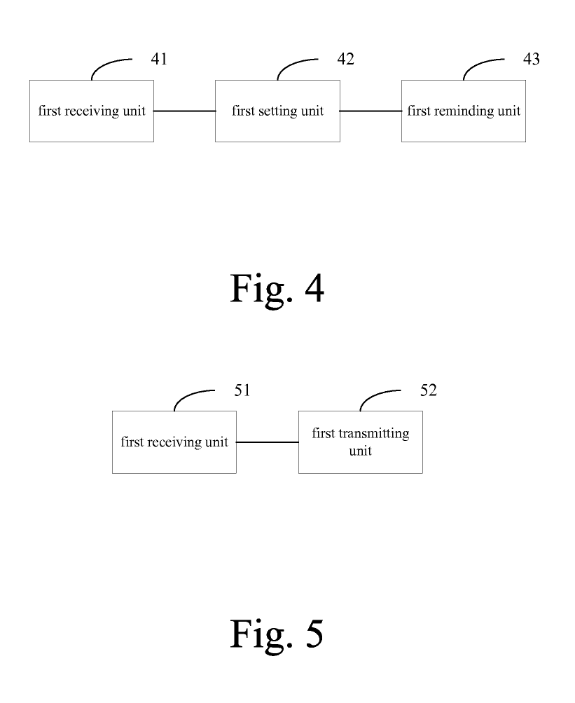

Based on the embodiments of the aforementioned methods, an embodiment of the present invention also provides a reminding device for playing a tone according to spending amount in real time, a schematic diagram for which is structurally detailed in FIG. 4, and the device comprises: the first receiving unit 41, the first setting unit 42, and the first reminding unit 43. The first receiving unit 41 is used for receiving an interval duration of playing a tone which is related to having spent the fixed amount from a charging system; the first setting unit 42 is used for setting an interval duration of playing a tone for reminding of the spending of the fixed amount according to the interval duration of playing a tone which is related to having spent the fixed amount; and the first reminding unit 43 is used for, when a call duration of a user reaches the interval duration of playing a tone for the reminding of the spending of the fixed amount, playing the tone which is for reminding of having spent the fixed amount to the user.

Preferably, the first receiving unit receives the interval duration of playing a tone which is related to having spent the fixed amount transmitted by the service control point, specifically through a charging request.

Preferably, the first receiving unit receives a duration after which a fee-rate will be switched transmitted by the service control point, through a charging request, i.e., the charging request received by the first receiving unit further comprises the duration after which a fee-rate will be switched. The device further comprises: a determining unit, the first transmitting unit, the second receiving unit, the second setting unit and the second reminding unit. The determining unit is used for determining whether the duration after which a fee-rate will be switched changes; the first transmitting unit is used for transmitting a charging request report to the service control point according to the duration after which a fee-rate will be switched upon the determining unit determines that the duration after which a fee-rate will be switched changes, so that the charging system re-precomputes the interval duration of playing a tone corresponding to spending the fixed amount; the second receiving unit is used for receiving the duration after which a fee-rate will be switched and the interval duration of playing a tone corresponding to spending the fixed amount re-precomputed by the charging system, transmitted from the service control point; the second setting unit is used for resetting the interval duration of playing a tone for reminding of the spending of the fixed amount according to the duration after which a fee-rate will be switched and the re-precomputed interval duration of playing a tone corresponding to spending the fixed amount; the second reminding unit is used for playing the tone which is for reminding of having spent the fixed amount to the user when the re-precomputed interval duration of playing a tone which is related to having spent the fixed amount is reached.

Preferably, the device further comprises the second transmitting unit for transmitting a charging request report of the time having been used by the user to the service control point, after communication of the user terminates; the switching unit for switching off the communication, when receiving, transmitted by the service control point, a communication-terminating message after finishing fee-deduction.

Preferably, the reminding device for playing a tone according to spending amount in real time can be integral to the mobile service switching center or the service support point, or self-deployed, which is not limited by the present embodiment.

Accordingly, an embodiment of the present invention further provides a reminding device for controlling of playing a tone according to spending amount in real time, a schematic diagram for which is structurally detailed in FIG. 5, and the device comprising: the first receiving unit 51 and the first transmitting unit 52. The first receiving unit 51 is used for receiving, transmitted from a charging system, an interval duration of playing a tone which is related to having spent the fixed amount, specifically through a credit control response message; the first transmitting unit is used for transmitting the interval duration of playing a tone which is related to having spent the fixed amount to the mobile service switching centre, specifically, transmitting used time and the interval duration of playing a tone which is related to having spent the fixed amount to the mobile service switching centre through a charging request, so that the mobile service switching centre plays a reminding tone to a user according to the interval duration of playing a tone which is related to having spent the fixed amount.

Preferably, the first receiving unit further receives a duration after which a fee-rate will be switched transmitted by the charging system, i.e., the credit control response message received by the first receiving unit further comprises the duration after which a fee-rate will be switched. The device further comprises: the second receiving unit, the second transmitting unit, the third receiving unit, the third transmitting unit, and the second control unit. The second receiving unit is used for receiving a charging request report transmitted, when the duration after which a fee-rate will be switched changes, by the mobile service switching center according to the duration after which a fee-rate will be switched; the second transmitting unit is used for transmitting the charging request report to the charging system; the third receiving unit is used for receiving the re-precomputed interval duration of playing a tone corresponding to spending the fixed amount and the duration after which a fee-rate will be switched transmitted by the charging system; the third transmitting unit is used for transmitting the re-precomputed interval duration of playing a tone corresponding to spending the fixed amount and the duration after which a fee-rate will be switched to the mobile service switching center, so that the mobile service switching center resets the interval duration of playing a tone which is related to having spent the fixed amount according to the duration after which a fee-rate will be switched and the re-precomputed interval duration of playing a tone corresponding to spending the fixed amount, and plays a reminding tone to the user when the re-precomputed interval duration of playing a tone which is related to having spent the fixed amount is reached.

Preferably, the reminding device for playing a tone according to spending amount in real time can be integral to a service control point or a service control point with the charging system, or self-deployed.

The charging system in the embodiments of the present invention is also the charging system in the system of the traditional intelligent network, or can be the charging system in the GSM network supporting AC signaling by using the CAMEL protocol, which is not limited by the present embodiment.

In the embodiments of the present invention, in addition to using fixed reminding sound, a sound identifier (ID) is distributed to the MSC and then the MSC performs corresponding sound reminding. In the present embodiment, in addition to adding new parameters in AC, an application of Play Tone can be extended, in which an interval duration of playing a tone is carried to the MSC, so that the MSC performs real-time sound play. In a case that the charge is simple and there is not charge switching during a conversation, similar functionality can be realized through allowing the MSC to play sound every other fixed duration during a conversation.

In the present embodiment, through extensions in the AC message of the CAMEL protocol, i.e., through extended new fields in the AC message, the interval duration of playing a tone and duration after which a fee-rate will be switched are separately delivered. In doing so, the MSC sets the content for playing a tone and the interval duration of playing a tone according to the received parameters for playing a tone in the AC, thereby addressing the problem of performing real-time sound play reminding on the user based on spending amount, improving the experience of the user in the GSM network, and attaining the objective of controlling the expenditure for a personal call in real time. In addition, for achieving the functionality of the reminding, the embodiments of the present invention do not need to establish any outbound link for playing a tone, which thus causes less impact on system performance than other schemes with established links for playing a tone. Further, the embodiments of the present invention do not need to frequently distribute the AC according to the duration corresponding to fixed amount, which allows no sharp degradation in the system performance due to frequent interaction of AC/ACR signaling, thus requiring no upgrading of the present network devices and no increase of the operating costs of an operator.

In the embodiments of the present invention, the relationship terms such as the first and the second are only used for distinguishing one entity or operation from the other entity or operation, which however not necessarily requires or implies there is any such actual relationship or order between these entities or operations. Further, the terms “comprising,” “including,” or any other variants thereof intend to cover exclusive comprising, which makes a process, method, matter of fact or devise comprising a series of elements includes not only those elements, but also other elements which are not specifically listed or inherent elements for such a process, method, matter of fact or devise. Without any more limitation, an element defined by the phrase “comprising one . . . ” does not exclude that the process, method, matter of fact or devise comprising the element also has other same element.

Through description of the above embodiments, those skilled in the art can clearly know the present invention can be implemented through combining software with a necessary hardware platform, or alternatively can be implemented through hardware; while the former embodiments could be a better one in more cases. Based on such understanding, the technical solution of the present invention or portion thereof contributing to the prior art can be embodies in the form of computer software product. Such computer software product can be stored in storage medium, such as read-only memory (ROM), random-access memory (RAM), disk, optics, etc., including instructions to cause one computer device (which can be personal computer, servers, network device, etc.) to execute the methods described by various embodiments of the present invention or certain portions thereof.

The above description is merely preferable embodiments of the present invention. It should be noted that, persons ordinary in the art can make several changes and improvements to the embodiments and application fields without departing from the concept of the present invention, and the changes and improvements should be within the scope of the present invention.

What is claimed is:

1. A reminding method for playing a tone according to spent amount in real time comprising:
receiving, from a service control point, an interval duration of playing a tone from a charging system, wherein the tone relates to having spent a fixed amount;
setting the interval duration of playing the tone according to the received interval duration of playing the tone, wherein the tone is configured to remind a user of having spent the fixed amount; and
playing the tone which is configured to remind the user of having spent the fixed amount to the user when a call duration of the user reaches the interval duration of playing the tone which is configured to remind the user of having spent the fixed amount.

2. The method of claim 1, wherein receiving, from the service control point, the interval duration of playing the tone which is related to having spent the fixed amount comprises receiving, from the service control point, the interval duration of playing the tone which is related to having spent the fixed amount through a charging request message.

3. The method of claim 1, further comprising receiving, from the service control point, a duration after which a fee-rate will be switched.

4. The method of claim 3, wherein when the duration after which the fee-rate will be switched has been exceeded and the fee-rate changes, the method further comprises:
transmitting a charging request report to the service control point according to the duration after which the fee-rate will be switched such that the service control point obtains an interval duration of playing a tone corresponding to having spent the fixed amount, wherein the interval duration is re-precomputed by the charging system;
receiving, from the service control point, the duration after which the fee-rate will be switched and the interval duration of playing the tone corresponding to spending the fixed amount re-precomputed by the charging system;
resetting the interval duration of playing the tone configured to remind the user of having spent the fixed amount according to the duration after which the fee-rate will be switched and the re-precomputed interval duration of playing the tone corresponding to spending the fixed amount; and
playing the tone configured to remind the user of having spent the fixed amount to the user when the re-precomputed interval duration of playing the tone which is related to having spent the fixed amount is reached.

5. The method of claim 1, further comprising:
transmitting a charging request report of the time having been used by the user to the service control point after communication of the user terminates; and
switching off the communication when a communication-terminating message is received from the service control point after fee-deduction is finished.

6. The method of claim 1, further comprising:
receiving, by the service control point, the interval duration of playing the tone which is related to having spent the fixed amount and is transmitted by the charging system; and
transmitting, by the service control point, the used time and the interval duration of playing the tone which is related to having spent the fixed amount to a mobile service switching center.

7. The method of claim 6, wherein when the duration after which the fee-rate will be switched has been exceeded and the fee-rate changes, the method further comprises:
receiving, by the service control point, the charging request report transmitted by the mobile service switching center according to the duration after which the fee-rate will be switched;
obtaining, by the service control point, the re-precomputed interval duration of playing the tone corresponding to spending the fixed amount and the duration after which the fee-rate will be switched from the charging system according to the charging request report;
transmitting, by the service control point, the re-precomputed interval duration of playing the tone corresponding to spending the fixed amount and the duration after which the fee-rate will be switched to the mobile service switching center such that the mobile service switching center resets a re-precomputed interval duration of playing the tone which is related to having spent the fixed amount according to the re-precomputed interval duration of playing the tone corresponding to spending the fixed amount and the duration after which the fee-rate will be switched; and
playing the tone configured to remind the user of having spent the fixed amount to the user when the re-precomputed interval duration of playing the tone which is related to having spent the fixed amount is reached.

8. The method of claim 7, wherein obtaining, by the service control point, the re-precomputed interval duration of playing the tone corresponding to spending the fixed amount and the duration after which the fee-rate will be switched from the charging system comprises:
transmitting, by the service control point, a credit control request to the charging system according to contents of the charging request report; and
receiving, by the service control point, a credit control response transmitted by the charging system, wherein the credit control response comprises a re-precomputed interval duration of playing the tone corresponding to spending the fixed amount and the duration after which the fee-rate will be switched.

9. A reminding device for playing a tone according to spent amount in real time comprising:
a first receiving unit configured to receive an interval duration of playing a tone from a charging system, wherein the tone relates to having spent a fixed amount;
a first setting unit configured to set the interval duration of playing the tone, wherein the tone is configured to remind a user of having spent the fixed amount according to the received interval duration of playing the tone which is related to having spent the fixed amount; and
a first reminding unit configured to play the tone which is configured to remind the user of having spent the fixed amount to the user when a call duration of the user reaches the interval duration of playing the tone which is configured to remind the user of having spent the fixed amount.

10. The device of claim 9, wherein the first receiving unit is configured to receive, from the service control point, the interval duration of playing the tone which is related to having spent the fixed amount through a charging request.

11. The device of claim 10, wherein the first receiving unit is configured to receive a duration after which a fee-rate will be switched that is transmitted by the service control point through the charging request, and wherein the device further comprises:
a determining unit configured to determine whether the duration after which the fee-rate will be switched has been exceeded;
a first transmitting unit configured to transmit a charging request report to the service control point according to the duration after which the fee-rate will be switched when the determining unit determines that the duration after which the fee-rate will be switched has been exceeded such that the charging system re-precomputes the interval duration of playing the tone corresponding to spending the fixed amount;
a second receiving unit configured to receive, from the service control point, the duration after which the fee-rate will be switched and the interval duration of playing the tone corresponding to spending the fixed amount re-precomputed by the charging system;
a second setting unit configured to reset the interval duration of playing the tone configured to remind the user of having spent the fixed amount according to the duration after which the fee-rate will be switched and the re-precomputed interval duration of playing the tone corresponding to spending the fixed amount; and
a second reminding unit configured to play the tone which is configured to remind the user of having spent the fixed amount to the user when the re-precomputed interval duration of playing the tone which is related to having spent the fixed amount is reached.

12. The device of claim 9, further comprising:
a second transmitting unit configured to transmit a charging request report of the time having been used by the user to the service control point after communication of the user terminates; and
a switching unit configured to switch off the communication when a communication-terminating message is received from the service control point after finishing fee-deduction.

13. The device of claim 9, wherein the reminding device for playing the tone according to the spent amount in real time is integrated into a mobile service switching center, a service switching point, or is self-deployed.

14. A reminding device for controlling a playing of a tone according to a spent amount in real time comprising:
a first receiving unit configured to receive, from a charging system, an interval duration of playing the tone which is related to having spent a fixed amount; and
a first transmitting unit configured to transmit the interval duration of playing the tone which is related to having spent the fixed amount to a mobile service switching center such that the mobile service switching centre plays a reminding tone to a user according to the interval duration of playing the tone which is related to having spent the fixed amount.

15. The device of claim 14, wherein the first receiving unit is configured to receive a duration after which a fee-rate will be switched that is transmitted by the charging system, and wherein the device further comprises:
a second receiving unit configured to receive a charging request report transmitted by the mobile service switching center according to the duration after which the fee-rate will be switched when the duration after which the fee-rate will be switched has been exceeded;
a second transmitting unit configured to transmit the charging request report to the charging system;
a third receiving unit configured to receive the re-precomputed interval duration of playing the tone corresponding to spending the fixed amount and the duration after which the fee-rate will be switched that is transmitted by the charging system; and
a third transmitting unit configured to transmit the re-precomputed interval duration of playing the tone corresponding to spending the fixed amount and the duration after which the fee-rate will be switched to the mobile service switching center such that the mobile service switching center resets a re-precomputed interval duration of playing the tone which is related to having spent the fixed amount according to the re-precomputed interval duration of playing the tone corresponding to spending the fixed amount and the duration after which the fee-rate will be switched, and playing the tone which is related to having spent the fixed amount to the user when the re-precomputed interval duration of playing the tone which is related to having spent the fixed amount is reached.

16. The device of claim 14, wherein the reminding device for controlling the playing of the tone according to the spent amount in real time is integrated into a service control point, is integrated to a service control point with the charging system, or is self-deployed.
